(19) United States
(12) Patent Application Publication
(10) Pub. No.: US 2010/0078976 A1
(43) Pub. Date: Apr. 1, 2010

(54) INFANT SAFETY SEAT WITH AN ADUSTABLE ACCOMMODATING SPACE

(75) Inventors: Hung-Chung HOU, Changhua County (TW); Kai Yu HUANG, Changhua County (TW); Celine PATTON, Fort Mill, SC (US); Kevin COPPAGE, Fort Mill, SC (US); Phillip PRZYBYLO, Fort Mill, SC (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LINK TREASURE LIMITED, Tai-Pao City (TW)

(21) Appl. No.: 12/351,646

(22) Filed: Jan. 9, 2009

(30) Foreign Application Priority Data
Sep. 30, 2008 (TW) 097217542

(51) Int. Cl. B60N 2/28

(52) U.S. Cl. 297/230.13; 297/250.1

(57) ABSTRACT

An infant safety seat with an adjustable accommodating space includes a multi-layer cushioning insert which is detachably insertable into an infant safety seat for accommodating an infant in different stages of growth with different sizes. The multi-layer cushioning insert comprises a first cushioning part and a second cushioning part both may detachably to overlap each other and connect into the accommodating space to provide the necessary support for keeping an infant in proper postural position. The first cushioning part includes a U-shaped head cushion part, U-shaped body cushion part and U-shaped leg cushion part for restricting the side moving of the infant. Further, for accommodating a smaller infant, the second cushioning part can be detachably overlapped onto the first cushioning part for further reducing the side moving space and upright moving space of the baby in the infant safety seat.

### BACKGROUND OF THE INVENTION

1. Field of the Invention

The present invention relates generally to an infant safety seat for accommodating an infant therein. More particularly, the present invention relates to an infant safety seat having a multi-layer cushioning insert for adjusting the accommodating space to keep the infant in proper postural position in different stage of growth with different size.

2. Description of the Related Art

All states require that children and infant be restrained in an appropriate car seat while in an operating vehicle. While the states differ on the exact maximum child size and age requirement, they all have laws that are designed to protect children and infant until they are old or big enough so that only seat belts provide appropriate safety.

Premature infants and low birth weight infants are now widely recognized to be at high risk of oxygen desaturation and secondary central apnea while restrained in infant car seats. The American Academy of Pediatrics recommends evaluating infants who are at risk for apnea, bradycardia and oxygen desaturation prior to discharge from the hospital.

Infant safety seat manufacturers have developed standard types and sizes of the seats to assure parents that not only are their infant safe but that they are compliant with the laws of the States. The current design of infant car seats provides a less than ideal fit for low birth weight and premature infants. Some infants have respiratory instability during their pre-discharge Car Seat Test and either fail the traditional car seat test or pass only after repeated attempt with rolled blanket or other various aftermarket props to improve positioning. As infants are growing fast, this often requires the parents to purchase more than one size of safety seat, although uneconomical.

Accordingly, there exists a need for an infant safety seat with adjustable accommodating space to accommodate infant of any size in different stage of growth, so as to emplace the infant in a physiologically and physically beneficial orientation and protect the infant from injury.

### SUMMARY OF THE INVENTION

The present invention provides an infant safety seat with an adjustable accommodating space includes a multi-layer cushioning insert which is detachably insertable into an infant safety seat for accommodating an infant in different stages of growth with different sizes.

The multi-layer cushioning insert comprises a first cushioning part and a second cushioning part both may detachably to overlap each other and connect into the accommodating space to provide the necessary support for keeping an infant in proper postural position.

The first cushioning part includes a U-shaped head cushion part, U-shaped body cushion part and U-shaped leg cushion part for reducing the side moving of the infant. Further, for accommodating a smaller infant, the second cushioning part can be detachably overlapped onto the first cushioning part for further reducing the side moving space and upright moving space of the baby in the infant safety seat.

Preferably, the U-shaped head cushion part may be formed with a depression at the middle portion thereof, to aid in positioning the infants head in a neutral position to aid in maintaining an open air way. Making a car seat with such a multi-layer cushioning insert would make it easier for family members and healthcare providers to provide a safe and proper fit in car seats carrying the smallest passengers without the need for a complicated set of instructions and the risk of the unreliable reproducibility of aftermarket propping.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view of the infant safety seat of the present invention before applying the multi-layer cushioning insert.

FIG. 2 is an exploded perspective view showing the multi-layer cushioning insert of the present invention, included a first cushioning part and a second cushioning part.

FIG. 3 is a perspective view of the first cushioning part of the multi-layer cushioning insert according to the present invention.

FIG. 4 is a schematic view showing an infant being accommodated in the first cushioning part of the multi-layer cushioning insert.

FIG. 5 is a perspective view showing the first cushioning part inserted in the infant safety seat for adjusting the accommodating space of the infant safety seat of the present invention.

FIG. 6 is a perspective view showing the first cushioning part and second cushioning part of FIG. 5 can be overlapped to each other.

FIG. 7 is a perspective view showing the multi-layer cushioning insert installed in the infant safety seat of the present invention.

### DETAILED DESCRIPTION OF THE PREFERRED EMBODIMENTS

Reference will now be made in detail to the preferred embodiments of the present invention, examples of which are illustrated in the accompanying drawings.

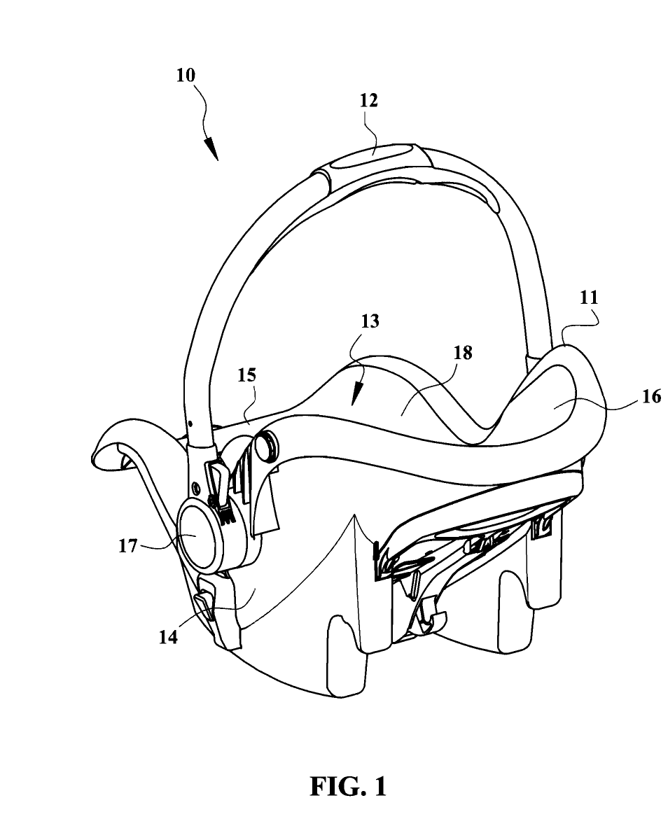

An embodiment of the invention includes an infant safety seat installed with an adjustable accommodating space. Referring to FIG. 1, the infant safety seat 10 includes a seat body 11, a handle 12, an accommodating space 13, a lateral side 14 and a front end 15. The accommodating space 13 has a main support face 16 and side support face 18. The handle 12 is connected to the lateral side 14 through a pair of pivot elements 17 thereby to permit the infant safety seat 10 also can be used as a traditional infant carrier.

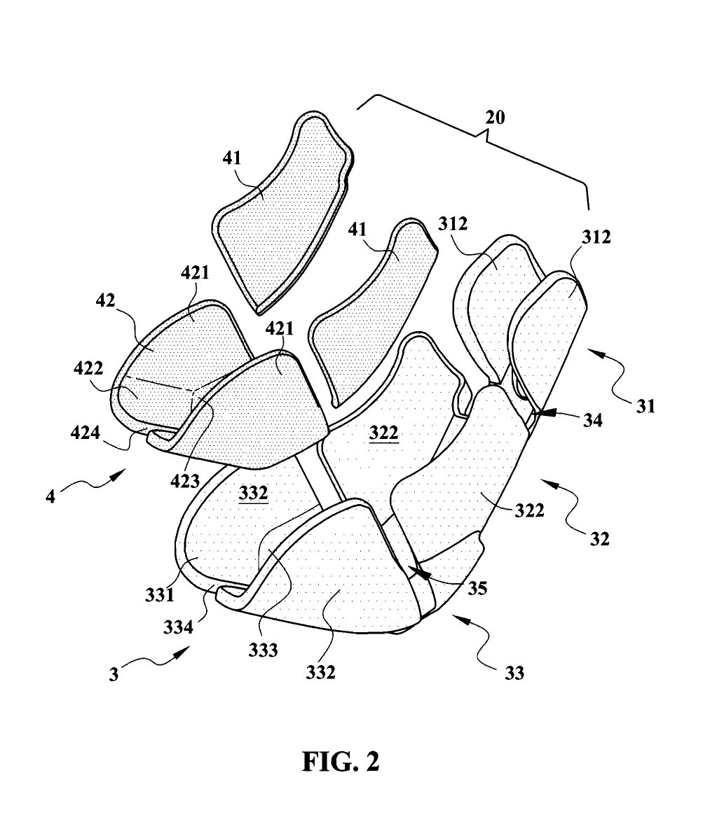

Referring now to FIG. 2, the multi-layer cushioning insert 20 includes at least a first cushioning part 3 and second cushioning part 4 both may detachably to overlap each other and connect into the accommodating space 13 for emplacing an infant in proper postural position therein.

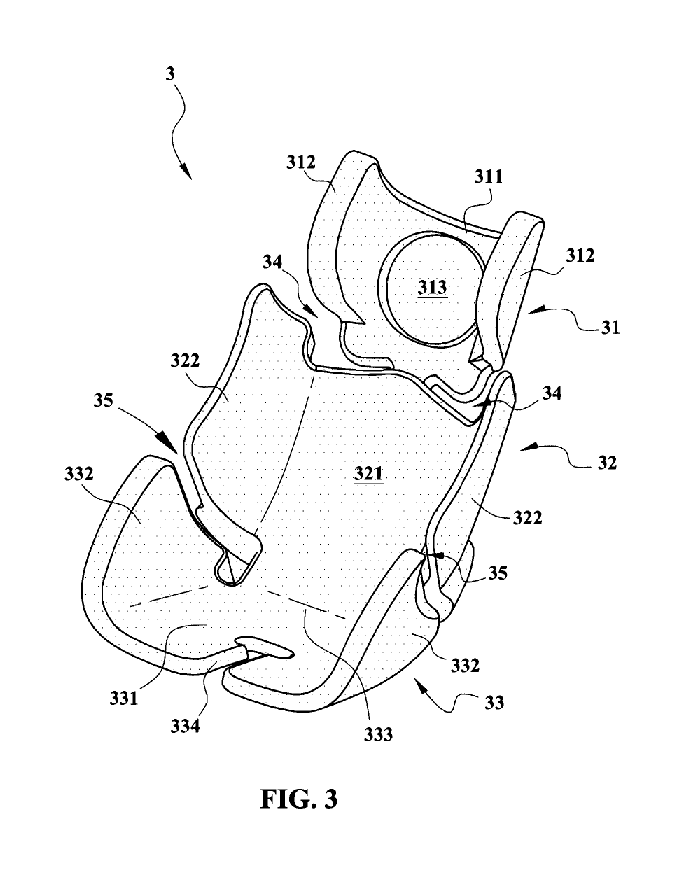

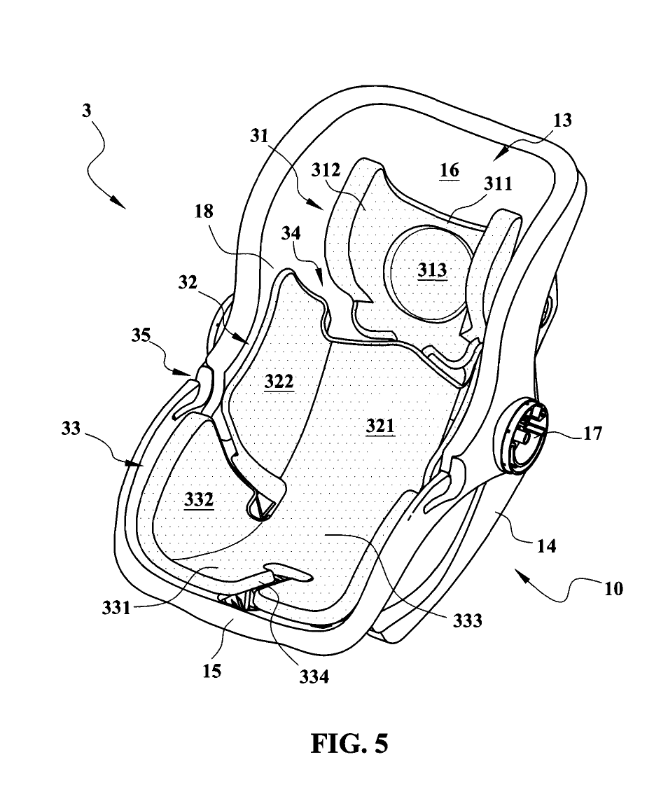

Referring now to FIGS. 3 to 5, the first cushioning part 3 may be formed as one piece and integral with a contour for detachably attaching into the accommodating space 13, which includes a U-shaped head cushion part 31, U-shaped body cushion part 32 and U-shaped leg cushion part 33 for restricting the side moving of the infant.

The U-shaped head cushion part 31 has a head support 311 and a pair of first side walls 312. Preferably, the head support 311 is formed with a depression 313 for emplacing an infant's head in proper postural position and keeping the infant's throat straightly.

The U-shaped body cushion part 32 includes a back support 321 and a pair of second side walls 322 for emplacing an infant's body in proper postural position, thereby to prevent the infant from side moving and rolling over during sleep, and lateral curvature of the infant's spine.

The U-shaped leg cushion part 33 is connected with the U-shaped body cushion part 32 and formed with a first leg support 331, a pair of third side walls 332 and buttocks support 333.

Referring back to FIG. 2, the second cushioning part 4 includes at least a pair of side cushion part 41 and a lower cushion part 42, wherein the lower cushion part 42 may include a pair of side walls 421, a second leg support 422 and a second buttocks support 423. The pair of side cushion part 41 can be detachably connected to the side walls 312 and 322 for reducing the infant's side moving space in the accommodating space 13. The lower cushion part 4 can be detachably connected to the U-shaped leg cushion part 33.

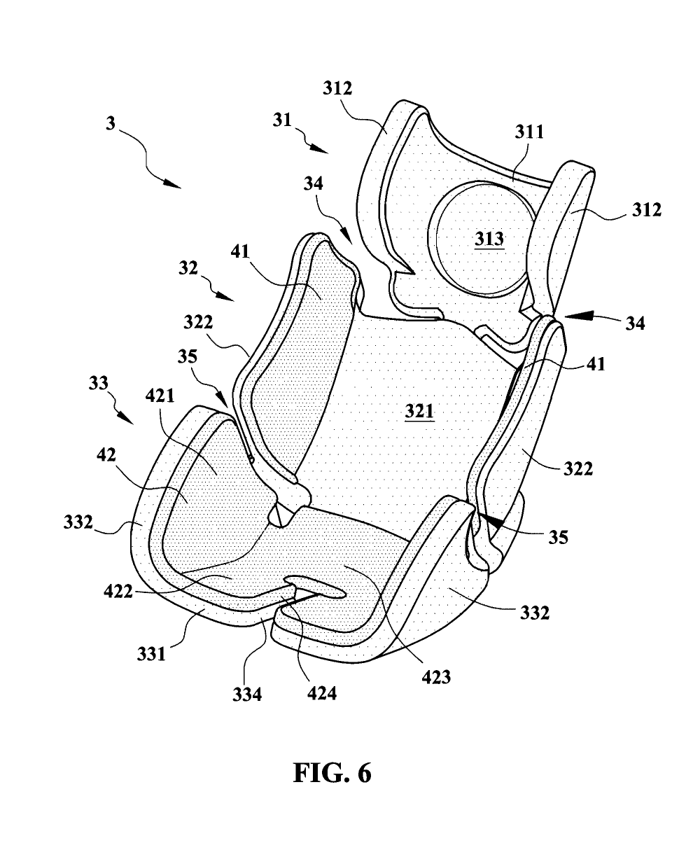

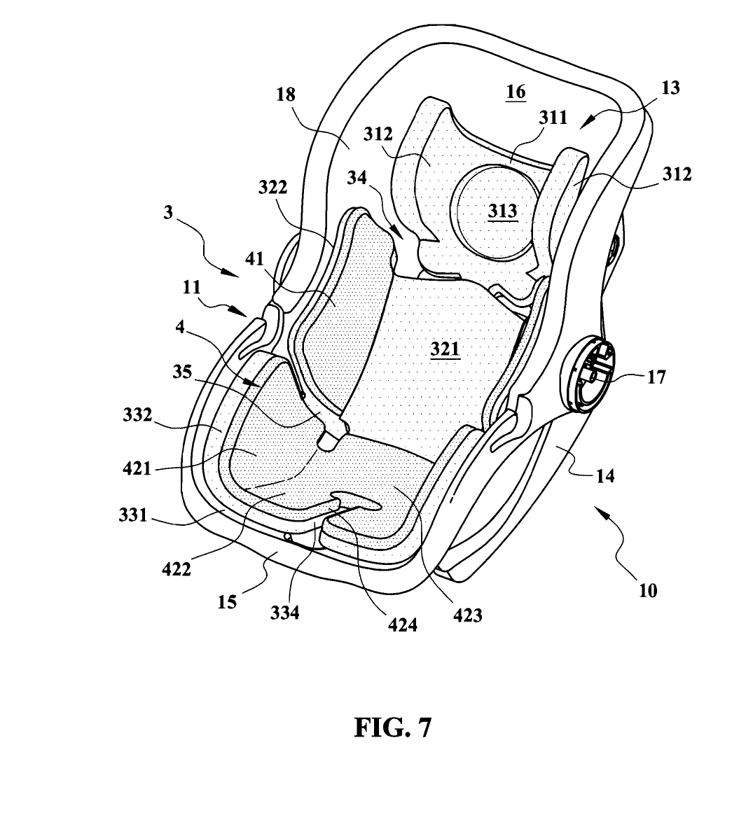

As being illustrated in FIGS. 6 and 7, when the second cushioning part 4 is overlapped onto the first cushioning part 3, it is useful for further reducing moving space in lateral and upright direction of the infant accommodated in the infant safety seat 10.

It is to be appreciated that the leg supports 331 and 422 may be formed with front opening 334 and 424 for passing a crotch belt (not shown). Further, the side openings 34 and 35 may be used to permit a shoulder belt (not shown) to pass through thereby to fix the infant's safety seat 10 and the multi-layer cushioning insert 20 to a car seat.

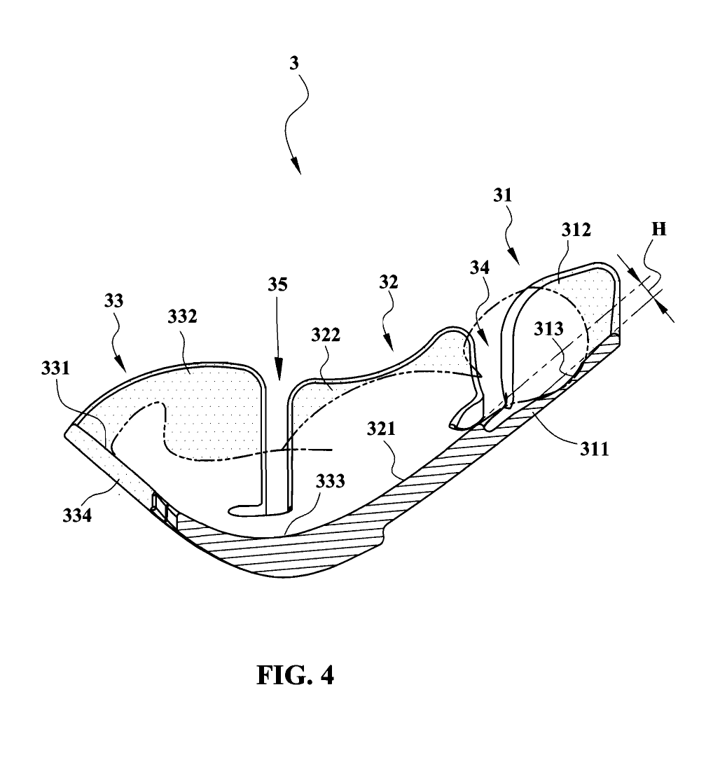

Referring back to FIG. 4, for adapting the first cushioning part 3, the side walls 312, 322, 332 are divided by a first side opening 34 and second side opening 35. It would also be appreciated, the thickness of back support 321 is larger than the head support 311 that creates a depth H to prevents the airway in throat of the infant from being bent.

The first cushioning part 3 and second cushioning part 4 are manufactured of cushioning media, such as cotton, Styrofoam, foam rubber, foam vinyl, Expanded Polypropylene (EPP), or any combination thereof, covered with a suitable skin manufactured of plastic, nylon, web or any suitable material.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. An infant safety seat with an adjustable accommodating space, comprising:
an infant safety seat, having an accommodating space and connected with a handle by a pair of pivot elements; and
a multi-layer cushioning insert which is detachably insertable into the infant safety seat for accommodating an infant in different stages of growth with different sizes.

2. The infant safety seat with an adjustable accommodating space of claim 1, wherein the multi-layer cushioning insert comprising at least a first cushioning part, for detachably attached in the accommodating space for emplacing an infant in proper postural position.

3. The infant safety seat with an adjustable accommodating space of claim 2, wherein the first cushioning part comprising:
a U-shaped head cushion part, having a head support and a pair of first side walls;
a U-shaped body cushion part, having back support and a pair of second side walls; and
a U-shaped leg cushion part, having a first leg support, a pair of side walls and a first buttocks support.

4. The infant safety seat with an adjustable accommodating space of claim 3, wherein the first cushioning part further comprising:
a pair of first side opening, between the first side walls and the second side walls; and
a pair of second side opening, between the second side walls and the third side walls.

5. The infant safety seat with an adjustable accommodating space of claim 3, wherein the back support having a thickness larger than the head support for keeping the infant's throat straightly.

6. The infant safety seat with an adjustable accommodating space of claim 3, wherein the head support is formed with a depression for emplacing an infant's head in proper postural position.

7. The infant safety seat with an adjustable accommodating space of claim 3, wherein the first leg support is formed with a front opening for passing a crotch belt thereby to secure the infant safety seat to a car.

8. The infant safety seat with an adjustable accommodating space of claim 3, wherein the first cushioning part may be formed as one piece and integral with a contour for detachably attaching into the accommodating space.

9. The infant safety seat with an adjustable accommodating space of claim 3, wherein the first cushioning part is manufactured of cushioning media.

10. An infant safety seat with an adjustable accommodating space, comprising:
an infant safety seat, having an accommodating space and connected with a handle by a pair of pivot elements; and
a first cushioning part, for detachably attached in the accommodating space; and
a second cushioning part, for detachably overlapping on the first cushioning part for emplacing an infant in proper postural position.

11. The infant safety seat with an adjustable accommodating space of claim 10, wherein the first cushioning part comprising:
a U-shaped head cushion part, having a head support and a pair of first side walls;
a U-shaped body cushion part, having back support and a pair of second side walls; and
a U-shaped leg cushion part, having a first leg support, a pair of side walls and a first buttocks support.

12. The infant safety seat with an adjustable accommodating space of claim 10, wherein the first cushioning part further comprising:
a pair of first side opening, between the first side walls and the second side walls; and
a pair of second side opening, between the second side walls and the third side walls.

13. The infant safety seat with an adjustable accommodating space of claim 11, wherein the back support having a thickness larger than the head support for keeping the infant's throat straightly.

14. The infant safety seat with an adjustable accommodating space of claim 11, wherein the head support is formed with a depression for emplacing an infant's head in proper postural position.

15. The infant safety seat with an adjustable accommodating space of claim 11, wherein the first leg support is formed with a front opening for passing a crotch belt thereby to secure the infant safety seat to a car seat.

16. The infant safety seat with an adjustable accommodating space of claim 11, wherein the first cushioning part may be formed as one piece and integral with a contour for detachably attaching into the accommodating space.

17. The infant safety seat with an adjustable accommodating space of claim 11, wherein the second cushioning part comprises:
a pair of side cushion part, for detachably connecting to the first and second side walls; and
a lower cushion part, for detachably connecting to the U-shaped leg cushion part, having a pair side walls, a second leg support and a second buttocks support.

18. An infant safety seat with an adjustable accommodating space, comprising:
an infant safety seat, having an accommodating space and connected with a handle by a pair of pivot elements; and
a layer of cushioning insert which is detachably insertable into the infant safety seat for accommodating an infant in different stages of growth with different sizes.

19. The infant safety seat with an adjustable accommodating space of claim 18, wherein the layer of cushioning insert comprising at least a first cushioning part, for detachably attached in the accommodating space for emplacing an infant in proper postural position.

20. The infant safety seat with an adjustable accommodating space of claim 19, wherein the first cushioning part comprising:
a U-shaped head cushion part, having a head support and a pair of first side walls;
a U-shaped body cushion part, having back support and a pair of second side walls; and
a U-shaped leg cushion part, having a first leg support, a pair of side walls and a first buttocks support.
